(19) United States
(12) Patent Application Publication
(10) Pub. No.: US 2002/0134727 A1
(43) Pub. Date: Sep. 26, 2002

(54) Delineated coffee filter

(76) Inventor: James Del Sordo, Downingtown, PA (US)

Correspondence Address: James Del Sordo, 32 Kristin Circle, Downingtown, PA, 19335, US

(21) Appl. No.: 09/817,306

(22) Filed: Mar. 26, 2001

(51) Int. Cl. B01D 29/00

(52) U.S. Cl. 210/497.01

(57) ABSTRACT

This improvement to the “everyday household” coffee filter will enable the ordinary brewer of coffee the ability to reliably measure the amount of coffee he or she places in the coffee filter. With this new found capability of measurement, the brewer of coffee will have ensured him or herself a consistent “strength” of their coffee.

### BACKGROUND OF THE INVENTION

Until this invention was conceived, the brewer of coffee was either forced to used some kind of measuring cup devise to judge their brew strength of their coffee or to just “eyeball” the amount of coffee placed into the coffee filter for brewing. The amount of water to be added to the pot is easily controlled and the only variable left for human judgment, is the amount of coffee placed in the coffee filter.

### SUMMARY OF THE INVENTION

The present invention provides a coffee filter with delineated markings or hash marks placed on the filter which would allow the brewer of coffee the ability to accurately gage the amount of coffee placed into the filter.

In one embodiment, generic hash marks would be placed on the filter allowing the brewer to find for him or herself the amount of coffee to be placed into the filter for their own particular “taste”. The marks would allow the brewer to constantly refer to these markings, and reproduce his or her own “strength” of the brewed coffee.

In another similar application, the coffee filter can be referenced to a particular coffee pot, allowing an easy gage for the novice and expert brewer of coffee the ability to get a baseline of their coffee's strength.

### DRAWING DESCRIPTION: BRIEF DESCRIPTION OF THE DRAWING

FIG. 1 is a perspective view of the delineated coffee filter. The “HASH MARKS” comprise concentric rings that are embossed either by printing or stamping the coffee filter. FIG. 2. is a cutaway view of the coffee filter showing various “levels” of which coffee can be measured by.

### DETAILED DESCRIPTION

### DESCRIPTION OF THE PREFERRED EMBODIMENTS

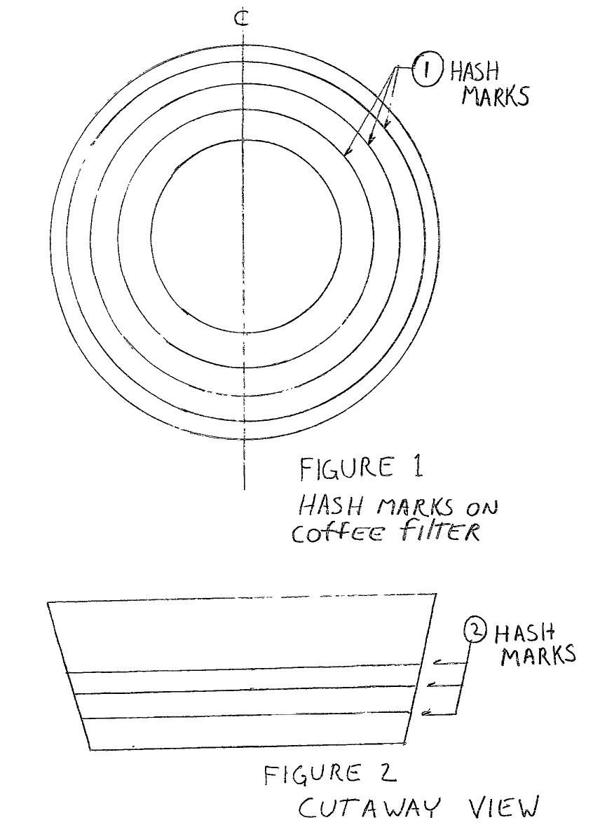

Referring to FIG. 1, a coffee filter with hash marks that would allow the brewer of coffee the ability to learn which marks on the filter he or she needs to use to get the desired strength of coffee, he or she desires. What I claim is:

1. A coffee filter (1) with preprinted or embossed delineated hash marks (2).

2. The coffee filter of claim 1, but the preprinted or embossed delineated hash marks are calibrated to the various types of coffee pots varying by manufacturer.
